(19) United States
(12) Patent Application Publication
(10) Pub. No.: US 2023/0182737 A1
(43) Pub. Date: Jun. 15, 2023

(54) VEHICLE DRIVING CONTROL METHOD AND VEHICLE DRIVING CONTROL APPARATUS

(71) Applicants: Hyundai Motor Company, Seoul (KR); Kia Corporation, Seoul (KR)

(72) Inventor: Jinyoung HWANG, Suwon-si (KR)

(73) Assignees: Hyundai Motor Company, Seoul (KR); Kia Corporation, Seoul (KR)

(21) Appl. No.: 17/874,811

(22) Filed: Jul. 27, 2022

(30) Foreign Application Priority Data
Dec. 9, 2021 (KR) 10-2021-0175977

(51) Int. Cl. B60W 30/18; B60W 30/14; B60W 30/182

(52) U.S. Cl. CPC B60W 30/18072; B60W 30/143; B60W 30/182; B60W 2552/20

(57) ABSTRACT

A vehicle driving control method includes: controlling, by a controller, a speed of an engine included in a vehicle and a torque of the engine so that fuel consumption of the vehicle is minimized in an acceleration section of the vehicle, based on gradient information of a road on which the vehicle is being driven and an air resistance of the vehicle; and controlling, by the controller, the vehicle to perform coasting driving in a coasting driving section of the vehicle after a speed of the vehicle reaches a maximum speed of an operation mode, in which the vehicle is accelerated and then performs the coasting driving, by the control of the speed of the engine and the torque of the engine.

### CROSS-REFERENCE TO RELATED APPLICATION

This application claims priority to and the benefit of Korean Patent Application No. 10-2021-0175977 filed in the Korean Intellectual Property Office on Dec. 9, 2021, the entire contents of which are incorporated herein by reference.

### TECHNICAL FIELD

The present disclosure relates to a vehicle. More particularly, the present disclosure relates to a vehicle driving control method and a vehicle driving control apparatus.

### BACKGROUND

In general, a cruise control system for a vehicle is a device for automatically driving a vehicle at a set vehicle speed without manipulation of an accelerator pedal by a driver of the vehicle, and is also referred to as an auto cruise control system.

Once a target vehicle speed is set by the driver's simple manipulation, the cruise control system controls the speed of the vehicle to the target vehicle speed set by the driver, thereby greatly reducing the manipulation of the accelerator pedal by the driver to improve driving convenience.

In a cruise control system according to the related art, when a required torque (cruise torque) for maintaining the target vehicle speed is determined, in an internal combustion engine vehicle such as a gasoline vehicle or a diesel vehicle, engine driving is controlled so that the output of the required torque may be achieved through cooperative control between controllers, thereby performing cruise driving to maintain the target vehicle speed.

When an internal combustion engine vehicle performs cruise driving, an engine operating point is determined by the vehicle speed and a gear shift stage regardless of an engine optimal operating line. Accordingly, the cruise driving of the internal combustion engine vehicle is disadvantageous in terms of fuel efficiency.

The above information disclosed in this Background section is only for enhancement of understanding of the background of the disclosure, and therefore it may contain information that does not form the related art that is already known in this country to a person of ordinary skill in the art.

### SUMMARY

The present disclosure has been made in an effort to provide a vehicle driving control method and a vehicle driving control apparatus capable of improving fuel efficiency of a vehicle by controlling a vehicle speed (or vehicle engine speed) to an optimal speed at which fuel consumption of the vehicle is minimized, in consideration of a vehicle running resistance due to wind applied to the vehicle that is being driven (for example, a vehicle having a smart cruise control function).

An exemplary embodiment of the present disclosure provides a vehicle driving control method including: controlling, by a controller, a speed of an engine present in a vehicle and a torque of the engine so that fuel consumption of the vehicle is minimized in an acceleration section of the vehicle, based on gradient information of a road on which the vehicle is being driven and an air resistance of the vehicle; and controlling, by the controller, the vehicle to perform coasting driving in a coasting driving section of the vehicle after a speed of the vehicle reaches a maximum speed of a first operation mode, in which the vehicle is accelerated and then performs the coasting driving, by the control of the speed of the engine and the torque of the engine.

When the vehicle performs the coasting driving, the vehicle driving control method may further include, controlling, by the controller, so that fuel is not supplied to the engine and controlling, by the controller, a gear shift stage of a transmission present in the vehicle to a neutral stage.

The vehicle driving control method may further include: calculating, by the controller, the air resistance based on an angle between the vehicle and wind applied to the vehicle.

The controller may calculate the angle between the vehicle and the wind based on driving direction information of the vehicle and direction information of the wind.

The vehicle driving control method may further include: setting, by the controller, an operation mode of the vehicle to the first operation mode in response to a selection signal received from a driver of the vehicle through an input device of the vehicle.

The vehicle driving control method may further include: setting, by the controller, an accelerator pedal of the vehicle to an OFF state in response to a request signal received from the driver of the vehicle through the input device.

Another embodiment of the present disclosure provides a vehicle driving control apparatus including: a navigation device generating gradient information of a road on which a vehicle is being driven; and a controller controlling a speed of an engine present in the vehicle and a torque of the engine so that fuel consumption of the vehicle is minimized in an acceleration section of the vehicle, based on the gradient information of the road and an air resistance of the vehicle, and the controller may control the vehicle to perform coasting driving in a coasting driving section of the vehicle after a speed of the vehicle reaches a maximum speed of a first operation mode, in which the vehicle is accelerated and then performs the coasting driving, by the control of the speed of the engine and the torque of the engine.

The vehicle driving control apparatus may further include: a wind speed information sensor detecting speed information of wind applied to the vehicle; and a wind direction information sensor detecting direction information of the wind, the controller may calculate the air resistance of the vehicle based on the speed information of the wind and the direction information of the wind.

When the vehicle performs the coasting driving, the controller may perform a control so that fuel is not supplied to the engine and controls a gear shift stage of a transmission included in the vehicle to a neutral stage.

The controller may calculate the air resistance based on an angle between the vehicle and wind applied to the vehicle.

The controller may calculate the angle between the vehicle and the wind based on driving direction information of the vehicle and direction information of the wind.

The controller may set an operation mode of the vehicle to the first operation mode in response to a selection signal received from a driver of the vehicle through an input device of the vehicle.

The controller may set an accelerator pedal of the vehicle to an OFF state in response to a request signal received from the driver of the vehicle through the input device.

The vehicle driving control method and the vehicle driving control apparatus according to the exemplary embodiment of the present disclosure may improve fuel efficiency of a vehicle by controlling a vehicle speed to an optimal speed at which fuel consumption of the vehicle is minimized, in consideration of a vehicle running resistance due to wind applied to the vehicle that is being driven.

### BRIEF DESCRIPTION OF THE DRAWINGS

A brief description of the drawings will be provided in order to allow the drawings used in a detailed description of the present disclosure to be sufficiently understood.

FIG. 1 is a flowchart for describing a vehicle driving control method according to an exemplary embodiment of the present disclosure.

FIG. 2 is a block diagram for describing a vehicle driving control apparatus to which the vehicle driving control method illustrated in FIG. 1 is applied.

FIG. 3 is a diagram for describing an air resistance among vehicle running resistances due to wind applied to a vehicle as illustrated in FIG. 2.

FIG. 4 is a diagram (graph) for describing an acceleration section and a coasting driving section of the vehicle as illustrated in FIG. 1.

### DETAILED DESCRIPTION OF THE EMBODIMENTS

In order to sufficiently understand the present disclosure and objects accomplished by executing the present disclosure, reference should be made to the accompanying drawings illustrating exemplary embodiments of the present disclosure and contents described in the accompanying drawings.

Hereinafter, the present disclosure will be described in detail by describing exemplary embodiments of the present disclosure with reference to the accompanying drawings. Further, in describing the present disclosure, well-known configurations or functions will not be described in detail since they may unnecessarily obscure the gist of the present disclosure. Throughout the drawings, the same reference numerals will denote the same components.

Terms used in the present specification are used only in order to describe specific exemplary embodiments rather than limiting the present disclosure. Singular forms are to include plural forms unless the context clearly indicates otherwise. It should be understood that the terms “include” or “have” used in the present specification specify the presence of features, numerals, steps, operations, components, parts mentioned in the present specification, or a combination thereof, but do not preclude the presence or addition of one or more other features, numerals, steps, operations, components, parts, or a combination thereof.

Throughout the present specification, when any one portion is referred to as being “connected to” another portion, it means that any one portion and another portion are “directly connected to” each other or are “electrically or mechanically connected to” each other with the other component interposed therebetween.

Unless being defined otherwise, the terms used in the present specification including technical and scientific terms have the same meanings as those that are generally understood by a person of an ordinary skill in the art. It should be understood that the terms defined by the dictionary are identical with the meanings within the context of the related art, and they should not be ideally or excessively formally defined unless the context clearly dictates otherwise.

A technology for improving vehicle fuel efficiency for a vehicle such as an autonomous vehicle or a vehicle having a smart cruise control function is being developed. The autonomous vehicle or the vehicle having the smart cruise control function, in which a driver of the vehicle does not control a throttle valve, determines an optimal vehicle speed corresponding to the minimum fuel consumption based on a brake specific fuel consumption (BSFC) map of an engine. According to the related art, the optimal vehicle speed is determined based on gradient information and traffic information of a road in front of the vehicle.

However, since the speed (or strength) and direction of wind affect a vehicle running resistance, the influence of the wind needs to be considered when determining the optimal vehicle speed.

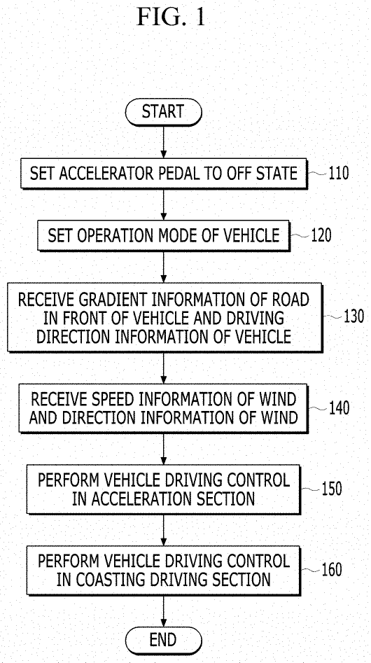

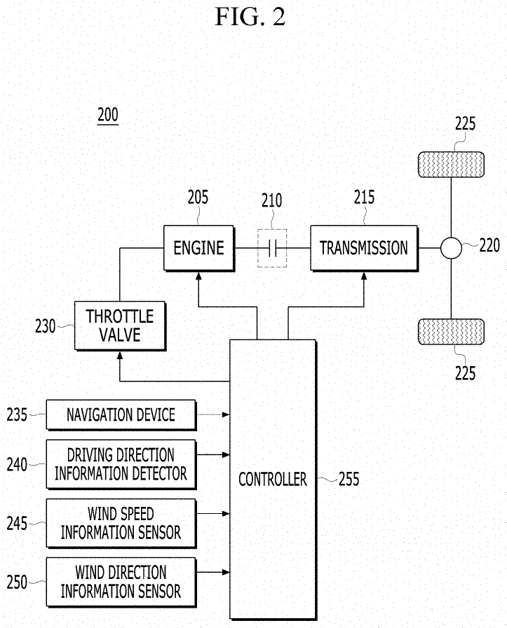

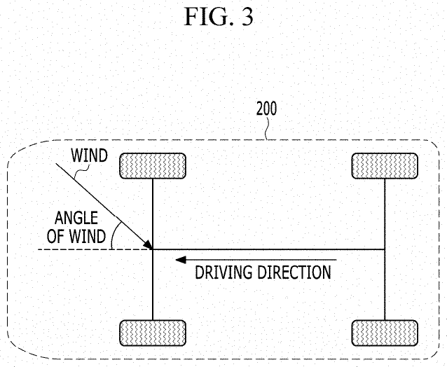

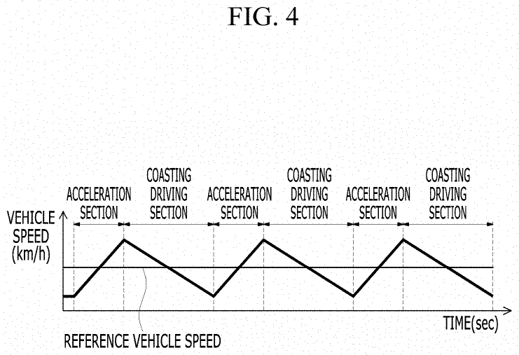

FIG. 1 is a flowchart for describing a vehicle driving control method according to an exemplary embodiment of the present disclosure. FIG. 2 is a block diagram for describing a vehicle driving control apparatus to which the vehicle driving control method illustrated in FIG. 1 is applied. FIG. 3 is a diagram for describing an air resistance among vehicle running resistances due to wind applied to the vehicle as illustrated in FIG. 2. FIG. 4 is a diagram (graph) for describing an acceleration section and a coasting driving section of the vehicle as illustrated in FIG. 1.

Referring to FIGS. 1 to 4, in a determination step 110, a controller 255 may set an accelerator pedal of a vehicle 200 to an OFF state in response to a request signal received from a driver of the vehicle 200 through an input device (for example, a cluster) of the vehicle 200.

As illustrated in FIG. 2, the vehicle 200 may include an engine 205, a clutch 210, a transmission 215, a final reduction gear device 220, driving wheels 225, a throttle valve 230, a navigation device 235, a driving direction information detector 240, a wind speed information sensor 245, a wind direction information sensor 250, and the controller 255. The vehicle driving control apparatus may include the navigation device 235, the driving direction information detector 240, the wind speed information sensor 245, the wind direction information sensor 250, and the controller 255.

The clutch 210 may transmit a torque of the engine 205 to the transmission 215 or may block the torque of the engine 205 from being transmitted to the transmission 215.

The throttle valve 230 may control the amount of air supplied to the engine 205.

The driving direction information detector 240 may detect driving direction information of the vehicle by using map information (or road map information) and vehicle location information. The map information may be a map that represents information regarding a road on which the vehicle is being driven and surrounding terrain with high accuracy. For example, the map information and the vehicle location information may be provided by the navigation device 235 including a global positioning system (GPS) receiver that generates the vehicle location information.

The controller 255, which is an electronic control unit (ECU), may control an overall operation of the vehicle 200. The controller 255 may be, for example, one or more microprocessors operated by a program (control logic) or hardware (for example, a microcomputer) including the microprocessors, and the program may include a series of instructions for performing the vehicle driving control method according to an exemplary embodiment of the present disclosure. The instructions may be stored in a memory of the vehicle 200.

In Step 120 illustrated in FIG. 1, after Step 110, the controller 255 may set, in response to a selection signal received from the driver of the vehicle through the input device of the vehicle, an operation mode of the vehicle to a coasting driving mode in which the vehicle is accelerated and then performs coasting driving (or coasting deceleration). After the coasting driving mode for improving the fuel efficiency of the vehicle 200 is set, the controller 255 may receive a reference vehicle speed that is input by the driver through the input device and is a cruise driving speed of the vehicle used in the coasting driving mode, a maximum vehicle speed (upper limit vehicle speed) of the vehicle, and a minimum vehicle speed (lower limit vehicle speed) of the vehicle.

In Step 130, after Step 120, the controller 255 may receive, from the navigation device 235, the gradient information of the road which is located in front of the vehicle 200 and on which the vehicle is being driven, and the controller 255 may receive the driving direction information of the vehicle as illustrated in FIG. 3 from the driving direction information detector 240. The navigation device 235 may receive the gradient information of the road from a server or a telematics server of an intelligent transport system (ITS) installed (located) outside the vehicle 200 and provide (or transmit) the gradient information to the controller 255.

In Step 140, after Step 130, the controller 255 may receive, from the wind speed information sensor 245, speed information of the wind applied to the vehicle 200, and the controller 255 may receive direction information of the wind from the wind direction information sensor 250. According to another exemplary embodiment of the present disclosure, the navigation device 235 may receive the speed information of the wind and the direction information of the wind from the telematics server and provide (or transmit) the speed information of the wind and the direction information of the wind to the controller 255.

The controller 255 may calculate an angle between the vehicle and the wind illustrated in FIG. 3 based on the driving direction information of the vehicle 200 and the direction information of the wind. The controller 255 may calculate an air resistance Fair among the vehicle running resistances based on the angle between the vehicle 200 and the wind. For example, the controller 255 may calculate the air resistance Fair by using the following equation.

$${F}_{air} = {C}_{d} \cdot A \cdot \frac{ρ}{2} \cdot \sqrt{{V}^{2} + {W}^{2} + 2 \cdot V \cdot W \cdot co s θ}$$

In the above equation, C_{d} represents an air resistance coefficient, A represents a frontal area of the vehicle, ρ represents an air density in the atmosphere, V represents the speed of the vehicle, W represents the speed of the wind, and θ represents the angle between the vehicle and the wind.

For example, the air resistance of the vehicle in a case where the wind blows from the front of the vehicle 200 that is being driven may be greater than the air resistance of the vehicle in a case where the wind does not blow from the front of the vehicle, and the air resistance of the vehicle in a case where the wind blows from behind the vehicle 200 that is being driven may be smaller than the air resistance of the vehicle in a case where the wind does not blow from behind the vehicle.

The running resistances of the vehicle 200 may include a rolling resistance, an air resistance, a gradient resistance (climbing resistance), and an acceleration resistance.

In Step 150, after Step 140, the controller 255 may control the speed of the engine 205 (or revolutions per minute (RPM) of the engine 205) and the torque of the engine so that the fuel consumption of the vehicle is minimized in the acceleration section of the vehicle as illustrated in FIG. 4, based on the gradient information of the road and the air resistance of the vehicle 200. When the speed of the engine 205 and the torque of the engine are controlled, the controller 255 may control an operation of the throttle valve 230.

The speed of the engine 205 and the torque of the engine based on the gradient information of the road and the air resistance of the vehicle 200 may be stored in the memory of the vehicle or the controller 255 and may be determined by a test (or experiment). An acceleration of the vehicle that is based on the gradient information of the road and the air resistance of the vehicle 200 and corresponds to the speed of the engine 205 and the torque of the engine based on the gradient information of the road and the air resistance of the vehicle 200 may be stored in the memory of the vehicle or the controller 255 and may be determined by a test (or experiment).

In Step 160, after the speed of the vehicle 200 reaches the maximum speed of the operation mode in which the vehicle is accelerated and then performs coasting driving, by the control of the speed of the engine 205 and the torque of the engine, the controller 255 may control the vehicle (or the engine 205) to perform coasting driving until the speed of the vehicle reaches the minimum speed of the operation mode in the coasting driving section of the vehicle as illustrated in FIG. 4. When the vehicle 200 performs coasting driving, the controller 255 may perform a control so that fuel is not supplied to the engine 205 and may control a gear shift stage of the transmission 215 to a neutral stage.

Components, “units”, “-er/or”, blocks, or modules used in an exemplary embodiment of the present disclosure may be implemented by software such as tasks, classes, sub-routines, processes, objects, execution threads, or programs performed in a predetermined region on a memory or hardware such as a field-programmable gate array (FPGA) or an application-specific integrated circuit (ASIC) and may be implemented by a combination of the software and the hardware. The components, the “units”, or the like, may be included in a computer readable storage medium or may be dispersed and distributed in a plurality of computers.

Hereinabove, exemplary embodiments have been disclosed in the drawings and the specification. Specific terms have been used in the present specification, but these specific terms are used only in order to describe the present disclosure and are not used in order to limit the meaning or limit the scope of the present disclosure as disclosed in the claims. Therefore, a person of an ordinary skill in the art will understand that various modifications and equivalent exemplary embodiments are possible from the present disclosure. Therefore, an actual technical protection scope of the present invention is to be defined by the technical spirit of the claims.

What is claimed is:

1. A vehicle driving control method comprising:
controlling, by a controller, a speed of an engine present in a vehicle and a torque of the engine so that fuel consumption of the vehicle is minimized in an acceleration section of the vehicle, based on gradient information of a road on which the vehicle is being driven and an air resistance of the vehicle; and
controlling, by the controller, the vehicle to perform coasting driving in a coasting driving section of the vehicle after a speed of the vehicle reaches a maximum speed of a first operation mode, in which the vehicle is accelerated and then performs the coasting driving, by the control of the speed of the engine and the torque of the engine.

2. The vehicle driving control method of claim 1, wherein:
when the vehicle performs the coasting driving, the vehicle driving control method further comprises controlling, by the controller, so that fuel is not supplied to the engine and controlling, by the controller, a gear shift stage of a transmission present in the vehicle to a neutral stage.

3. The vehicle driving control method of claim 1, further comprising:
calculating, by the controller, the air resistance based on an angle between the vehicle and wind applied to the vehicle.

4. The vehicle driving control method of claim 3, wherein:
the controller calculates the angle between the vehicle and the wind based on driving direction information of the vehicle and direction information of the wind.

5. The vehicle driving control method of claim 1, further comprising:
setting, by the controller, an operation mode of the vehicle to the first operation mode in response to a selection signal received from a driver of the vehicle through an input device of the vehicle.

6. The vehicle driving control method of claim 5, further comprising:
setting, by the controller, an accelerator pedal of the vehicle to an OFF state in response to a request signal received from the driver of the vehicle through the input device.

7. A vehicle driving control apparatus comprising:
a navigation device providing gradient information of a road on which a vehicle is being driven; and
a controller controlling a speed of an engine present in the vehicle and a torque of the engine so that fuel consumption of the vehicle is minimized in an acceleration section of the vehicle, based on the gradient information of the road and an air resistance of the vehicle, and the controller controls the vehicle to perform coasting driving in a coasting driving section of the vehicle after a speed of the vehicle reaches a maximum speed of a first operation mode, in which the vehicle is accelerated and then performs the coasting driving, by the control of the speed of the engine and the torque of the engine.

8. The vehicle driving control apparatus of claim 7, further comprising:
a wind speed information sensor detecting speed information of wind applied to the vehicle; and
a wind direction information sensor detecting direction information of the wind,
wherein the controller calculates the air resistance of the vehicle based on the speed information of the wind and the direction information of the wind.

9. The vehicle driving control apparatus of claim 7, wherein:
when the vehicle performs the coasting driving, the controller performs a control so that fuel is not supplied to the engine and controls a gear shift stage of a transmission included in the vehicle to a neutral stage.

10. The vehicle driving control apparatus of claim 7, wherein:
the controller calculates the air resistance based on an angle between the vehicle and wind applied to the vehicle.

11. The vehicle driving control apparatus of claim 10, wherein:
the controller calculates the angle between the vehicle and the wind based on driving direction information of the vehicle and direction information of the wind.

12. The vehicle driving control apparatus of claim 7, wherein:
the controller sets an operation mode of the vehicle to the first operation mode in response to a selection signal received from a driver of the vehicle through an input device of the vehicle.

13. The vehicle driving control apparatus of claim 12, wherein:
the controller sets an accelerator pedal of the vehicle to an OFF state in response to a request signal received from the driver of the vehicle through the input device.
